(19) United States
(12) Patent Application Publication
(10) Pub. No.: US 2015/0366749 A1
(43) Pub. Date: Dec. 24, 2015

(54) LOVE BOX

(71) Applicant: Selso Perez, Yucaipa, CA (US)

(72) Inventor: Selso Perez, Yucaipa, CA (US)

(21) Appl. No.: 14/743,760

(22) Filed: Jun. 18, 2015

Related U.S. Application Data
(60) Provisional application No. 62/013,766, filed on Jun. 18, 2014.

(51) Int. Cl. A61H 19/00

(52) U.S. Cl. CPC A61H 19/50

(57) ABSTRACT

A portable structure that supports a wide variety of sexual positions to further enhance a couple's sex life, comprising: an upright, rectangularly shaped open framework including a square shaped base, a vertical support beam in each corner, a second square support positioned at the top of each beam, further comprising arms hingedly mounted to and spaced apart along the length of each vertical support beam, wherein the arms are capable of rotation in a horizontal plane to accommodate a wide variety of support positions.

### CLAIM OF PRIORITY

This patent application claims priority under 35 USC 119 (e) (1) from U.S. Provisional Patent Application Ser. No. 62/013766 filed Jun. 18, 2014, of common inventorship herewith entitled, “Portable Love Box,” which is incorporated herein by reference as though the same were set forth in its entirety.

### FIELD OF THE INVENTION

The present invention pertains to the field of love making, and more specifically to the field of devices to enhance love making.

### BACKGROUND OF THE INVENTION

The prior art has put forth several designs for devices to enhance love making. Among these are:

U.S. Pat. No. 6,745,774 to Jeffrey E. Fessler describes a platform chair for sexual intercourse that includes front and rear legs connected to each other by cross braces. A horizontal flat supporting platform connects the legs and cross braces. The platform supports a cushioned surface. The cushioned surface is connected to the horizontal platform by a number of springs, usually five. The cushioned surface slopes from the upper head to the lower hip sections. In front and below the hip section of the cushion is a padded seat. The seat is used by the dominant partner and is located between the legs. A handrail is also located above the flat padded support such that it is within easy reach of either participant. Supine footrests are located in front of the hip portion of the cushion and above the seat for use when the non dominant partner is in a supine position. A flat solid platform is located beneath the cushion such that either the dominant or non dominant participant can support themselves, their feet or other parts of their body for use in other sexual intercourse positions. The flat cushioned support is connected to the platform by the springs such that the participants can achieve a rocking, lateral or forward motion with minimal efforts.

US Patent 2003/0126686 to William Nash describes an apparatus for use in performing intercourse includes a frame having an operative side and a swing assembly. The swing assembly has at least two suspension joints. This swing assembly is attached to the frame through the two suspension joints to allow the assembly to swing arcuately. The two suspension joints are reciprocatable about different centers of gyration. The swing assembly has a platform allowing a first person to rest thereon and provides genital access toward the operative side. The swing assembly has clearance to allow a second person to stand adjacent the platform and gain access to said first person from the operative side as the swing assembly swings arcuately.

U.S. Pat. No. 4,449,521 to Jack S. Panzer describes a genital splint permitting a male to achieve penetration during sexual intercourse, The genital splint comprises a base adjacent the torso, an adjustable collar compressingly engaging the glans of the penis and adjustable support column means for maintaining the collar in an adjustable yet fixed position relative to the base. Preferably, a pliable material such as silicon tubing covers each of these elements for comfort and to prevent damage to body tissues during intercourse. Adjustment of the length of the support column means occurs by either telescopic or threaded engagement of an inner rod and an outer tube, the rod and tube each being attached to one of the collar and the base.

None of these prior art references describe the present invention.

### SUMMARY OF THE INVENTION

It is an object of the present invention to provide a portable structure that supports a wide variety of sexual positions to further enhance a couple's sex life.

### BRIEF DESCRIPTION OF THE DRAWINGS

FIG. 1 is an illustrative top down diagonal view showing adjustable swinging flat pads, pin holes and a bottom base support.

FIG. 2 is an illustrative side view showing adjustable flat padded supports for arms and legs and safety pins for each support.

FIG. 3 is an illustrative top down view showing the present invention's structure manufactured with titanium light metal.

FIG. 4 is an illustrative top down view showing swinging flat pads with adjustable extensions.

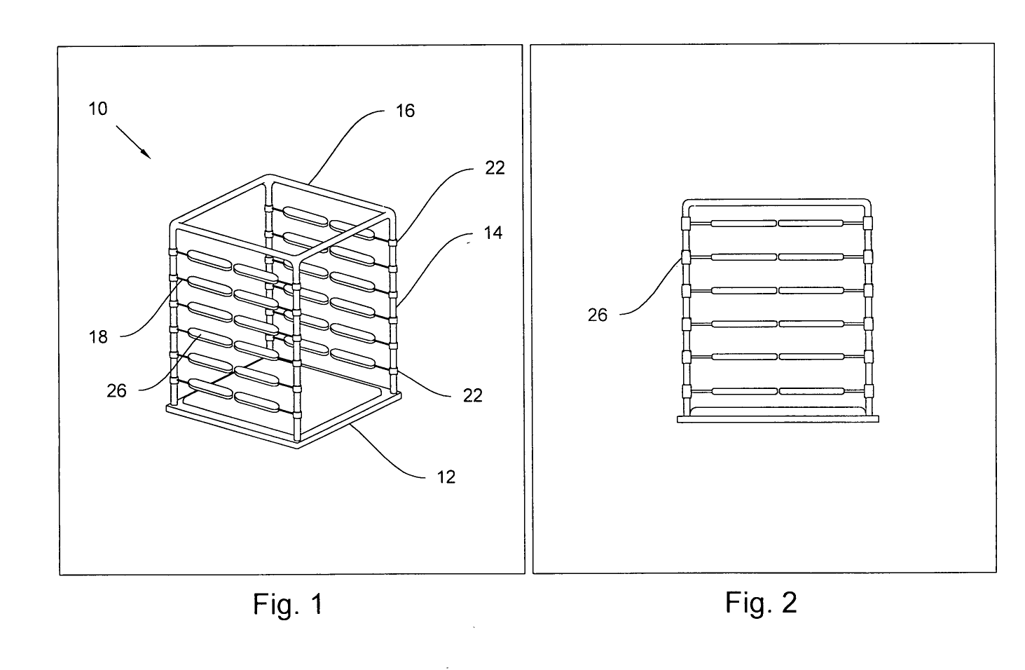

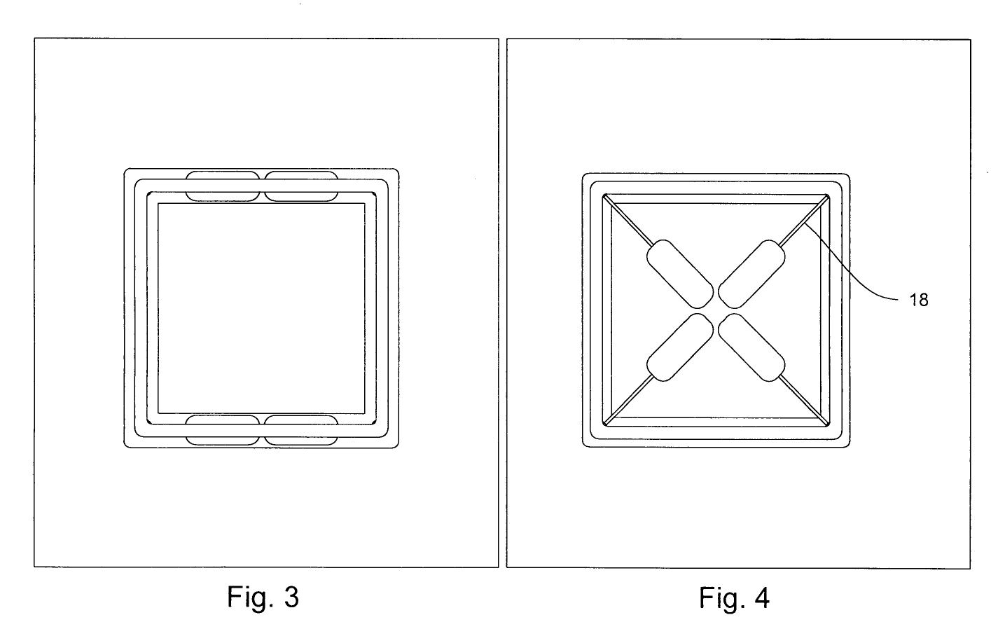

### DETAILED DESCRIPTION OF THE INVENTION

Sex is a healthy and natural part of life. A physical expression of love, commitment or simple passion, a healthy sex life is invigorating and meaningful. For most sexually active men and women, sex involves the conscious, positive expression of sexual energy in ways that enhance self esteem, physical health and an emotional relationship. Mutually beneficial and pleasurable, consensual sex is a strong cornerstone for most coupled relationships. Because sex is so physically and emotionally gratifying, a healthy sex life is a key component of most coupled partnerships and a natural part of life for many single people as well. Once a subject never openly discussed in proper society, a healthy outlook on sex is now being embraced by consumers from all walks of life.

The present invention, hereinafter referred to as The Love Box, is a portable structure comprising a variety of adjustable dedicated supports for holding one's arms and legs. The present invention provides coupled partners with a simple means of comfortably achieving a wide variety of sexual positions, thus providing consenting consumers a simple means of enhancing their sex lives. The Love Box is an easily assembled upright support structure that is utilized by those engaged in sexual intercourse to comfortably maintain a wide variety of sexual positions.

The Love Box is manufactured primarily of lightweight, yet heavy duty aluminum or titanium alloy material. The various support components of the device are encased within a padded foam sheathe to facilitate optimal comfort during use. The Love Box is comprised of interlocking components that facilitate quick assembly and installation, and also enable a user to effortlessly disassemble and compact the structure following use.

When fully assembled, The Love Box is an upright, rectangularly shaped open framework measuring approximately six feet in height, five feet in width and five feet in total depth, thus accommodating adults of various heights and statures. As an open framework, The Love Box 10 comprises a square shaped base 12 that contains a vertical support beam 14 in each corner. A second square support 16 is positioned at the top of the present invention, mirroring the position of the base support brace and providing structural integrity.

Hinge connected to each of the vertical support beams 14 and facing inwards is a series of strategically placed support arms 18. Arms 18 are hingedly mounted to beam 14 and are capable of rotation in a horizontal plane to accommodate a wide variety of support positions. Constructed to fold outwards and out of the way between the beams 14 when not in use, these heavy duty hinged arms 18 are angled inwards at any number of positions to provide adjustable braces on which to stand, lean or grab onto when engaged in sexual intercourse.

A series of six, arms 18 run down the center of each support beam 14, thus twenty four arms 18 are included in The Love Box. Fully adjustable, these arms 18 are raised or lowered on the individual beam 14 on which it is mounted, to adjust the present invention to accommodate one's stature or sexual position. These hinged arms 18 are mounted to the vertical support beams 14 by means of sliding hinges 22, with heavy duty locking safety pin fasteners 26 included for securing each arm 18 at the designated position along the beam 14. These arms 18 are encased within cushiony padded foam sheathes 26, affording optimal comfort during use. These adjustable, hinged and swinging arms 18 easily support the weight of adult users from light to heavy weights. For practical purposes, a simple storage bag or box is included with The Love Box for storing the components of the device when disassembled.

Use of The Love Box is simple and straight forward. First, a user assembles the present invention in a desired area within the home such as in a bedroom or other private space. Following packaging instructions, the user assembles The Love Box upright, making sure that the sturdy square base rests flat on the ground and the four vertical support beams 14 are positioned upright in each corner of the base 12. Properly assembled, the second square support 16 frames the top of the present invention, providing structural integrity to the structure.

The user next moves the hinged arms 18 to the desired position along the individual support beams 14. For instance, a female may place a set of flat padded arms 18 in mid position along the outer support beams 14 to comfortably support her legs off the ground, while additional arms 18 are angled outwards to easily grip onto when engaged in sexual activity. Thus assembled, the present invention is ready for use with the user standing, leaning, gripping or otherwise manipulating the various supports to achieve a wide array of sexual positions.

At a minimum, users can achieve one hundred different sexual positions with The Love Box. With the weight of the body supported by The Love Box, consenting partners achieve deep penetration and intense enjoyment in a comfortable and safe manner. Partners may change positions throughout their lovemaking, enabling them to achieve optimal sensory pleasure. After use, The Love Box is easily disassembled and stored away until needed again.

Completely comfortable to use, The Love Box's padded support arms enable a user to safely stand, lean against, hold onto, or otherwise manipulate the present invention to achieve positions impossible to achieve in bed. Adding a new dimension of playfulness to a partnership, The Love Box provides couples with a simple means of bringing a sense of excitement and adventure back into the bedroom. The Love Box is safely employed by overweight individuals, persons who suffer limited mobility, seniors and virtually any other consenting adult. Completely portable and durably constructed, The Love Box will withstand repeated wear, with ease.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A portable structure that supports a wide variety of sexual positions to further enhance a couple's sex life, comprising: an upright, rectangularly shaped open framework including a square shaped base, a vertical support beam in each corner, a second square support positioned at the top of each beam, further comprising arms hingedly mounted to and spaced apart along the length of each vertical support beam, wherein the arms are capable of rotation in a horizontal plane to accommodate a wide variety of support positions.

2. The structure of claim 1 wherein each arm is encased within a cushiony padded foam sheath.

3. The structure of claim 1 wherein each arm hingedly mounted to the vertical support beam by means of a sliding hinge, with heavy duty locking safety pin fasteners for securing each arm at the designated position along the beam.

4. The structure of claim 1, wherein there are six arms on each beam.

5. The structure of claim 1, wherein the arms are capable of being raised or lowered on the beam.

6. The structure of claim 1, wherein the arms are capable of swinging in or out of the structure to provide adjustable braces on which to stand, lean or grab onto when engaged in sexual intercourse.

7. The structure of claim 1, wherein the structure measures approximately six feet in height, five feet in width and five feet in total depth, thus accommodating adults of various heights and statures.
